(19) United States
(12) Patent Application Publication
(10) Pub. No.: US 2023/0129496 A1
(43) Pub. Date: Apr. 27, 2023

(54) METHOD FOR INCREASING EFFECTIVE CONTENT OF NUTRITIONAL COMPONENTS OF WINGED BEAN PODS AND APPLICATION THEREOF

(71) Applicants: HUAIHUA UNIVERSITY, Huaihua (CN); HUNAN XUEFENGSHAN SIYUAN TEA CO., LTD., Huaihua (CN)

(72) Inventors: Yuanzhi Yao, Huaihua (CN); Changling Li, Huaihua (CN); Wenzhuo Wang, Huaihua (CN); Jiang Wang, Huaihua (CN); Xianjun Mao, Huaihua (CN); Dexiu Huang, Huaihua (CN); Rujie Wang, Huaihua (CN); Yang Li, Huaihua (CN)

(21) Appl. No.: 17/565,235

(22) Filed: Dec. 29, 2021

(30) Foreign Application Priority Data
Oct. 26, 2021 (CN) 202111247731.2

(51) Int. Cl. A23K 10/30; A23K 10/14; A23K 40/00

(52) U.S. Cl. CPC A23K 10/30; A23K 10/14; A23K 40/00

(57) ABSTRACT

The present disclosure provides a method for increasing content of nutritional components of winged bean pods and an application thereof, which belongs to the technical field of deep processing of agricultural products. The method provided in the present disclosure comprises the following steps: (1) soaking a winged bean pod in water and mixing with an aqueous sodium chloride solution, and then steaming to obtain a softened pod; and (2) treating the softened pod with an alkaline substance or an acidic substance or cellulase. The present disclosure uses physical, chemical, and biological treatment methods to process the winged bean pods, and aims to find a method to increase the content of nutritional components of the pods and the palatability of animals, in order to better apply the pods to feed.

### CROSS REFERENCE TO RELATED APPLICATION

This patent application claims the benefit and priority of Chinese Patent Application No. 202111247731.2 filed on Oct. 26, 2021, the disclosure of which is incorporated by reference herein in its entirety as part of the present application.

### TECHNICAL FIELD

The present disclosure belongs to the technical field of deep processing of agricultural products, and specifically relates to a method for increasing content of nutritional components of winged bean pods and an application thereof.

### BACKGROUND ART

The tender pods, tender leaves and flowers of winged beans are all nutritious and delicious vegetables with high edible value. Many countries are vying to develop and utilize them as new high-protein food resources and vegetable resources, which can solve the deficiency problem of human food and protein. At present, there are many studies on the pretreatment of crop stalks or by-products of crop processing to improve the nutritional value and palatability for feeding, but there are no reports on the research of winged bean pods.

### SUMMARY

In view of this, the object of the present disclosure is to provide a method for increasing content of nutritional components of winged bean pods, which may improve the palatability for animals and better apply the pods to feed.

In order to achieve the above objective, the present disclosure provides the following technical schemes:

The present disclosure provides a method for increasing content of nutritional components of winged bean pods, comprising the following steps: (1) soaking a winged bean pod in water and mixing with an aqueous sodium chloride solution, and then steaming to obtain a softened pod; and (2) treating the softened pod with an alkaline substance, an acidic substance or cellulase.

In some embodiments, the nutritional components of the pods include crude protein, crude fat, crude fiber, crude ash, calcium and phosphorus.

In some embodiments, during the soaking in step (1), a mass ratio of the pods to water is 1:0.5-1.5; and a soaking time is 3-6 h.

In some embodiments, during the mixing in step (1), a mass percentage of sodium chloride in the aqueous sodium chloride solution is 1%, and a weight ratio of the aqueous sodium chloride solution to the pods after soaking is 1: 1-3.

In some embodiments, after the mixing, the method further comprises standing in a closed environment, and a standing time is 12-24 h.

In some embodiments, the steaming in step (1) is steaming at 90-100° C. for 50-70 min.

In some embodiments, the alkaline substance in step (2) comprises sodium hydroxide, quicklime, slaked lime, aqueous ammonia or urea; and the acidic substance comprises sulfuric acid.

In some embodiments, when the softened pods are treated with sodium hydroxide, an aqueous solution of the sodium hydroxide is mixed with the softened pods and then sealed for 10-14 h; a mass ratio of the aqueous solution of the sodium hydroxide to the softened pods is 1: 2-5; and a mass percentage of sodium hydroxide in the aqueous solution of the sodium hydroxide is 1-2%;

When the softened pods are treated with quicklime, the quicklime is mixed with the softened pods and water, and then sealed for 24-36 h; and a mass ratio of the quicklime, softened pods and water is 1:75-125:200-300;

When the softened pods are treated with slaked lime, the slaked lime is mixed with the softened pods and water, and then sealed for 24-36 h; and a mass ratio of the slaked lime, softened pods and water is 3:75-125:200-300;

When the softened pods are treated with aqueous ammonia, analytically pure aqueous ammonia is mixed with the softened pods at a mass ratio of 1:25-40, and then sealed for 25-35 d; and a mass percentage of ammonia in the aqueous ammonia is 8-12%;

When the softened pods are treated with an aqueous urea solution, the aqueous urea solution is mixed with the softened pods at a mass ratio of 1:25-40, and then sealed for 30-35 d; and a mass percentage of urea in the aqueous urea solution is 3-7%;

When the softened pods are treated with an aqueous sulfuric acid solution, the aqueous sulfuric acid solution is mixed with the softened pods at a ratio of 5-15 mL:1 g, and reacted at 120° C. for 30 min; and a mass percentage of sulfuric acid in the aqueous sulfuric acid solution is 0.5-1.5%.

In some embodiments, when the softened pods are treated with cellulase, the softened pods are allowed to stand at 75° C. for 8-12 h to balance the moisture, the softened pods after the balance of moisture are mixed with an acetic acid-sodium acetate buffer containing cellulase with a pH of 4.85 and hydrolyzed at 50° C. for 24 h; a mass ratio of the softened pods after the balance of moisture to the acetic acid-sodium acetate buffer containing cellulase is 5-15 g:1 mL; and a mass volume concentration of cellulase in the acetic acid-sodium acetate buffer containing cellulase is 2.5 mg/mL.

Compared with the prior art, the present disclosure has the following beneficial effects: the present disclosure uses physical, chemical, and biological treatment methods to process the winged bean pods, and aims to find a method for increasing the content of nutritional components of the pods and the palatability for animals, in order to better apply the pods to feed.

(1) After the sodium hydroxide treatment, the nutritional components of the winged bean pods changes significantly: the content of crude protein is significantly increased after treatment, reaching 32.53%; the contents of crude fiber, crude fat, phosphorus and total energy are significantly reduced; and the content of crude ash is significantly increased, with an increase of 61.81%;

(2) After lime (quicklime/slaked lime) treatment, the content of crude protein is significantly increased by 24.33%; the contents of crude fat, crude ash, calcium and phosphorus are significantly increased; and the content of crude fiber is significantly reduced, and at the same time the total energy is significantly reduced;

(3) After ammoniating treatment, the content of crude protein is significantly increased by 86.28%, and the contents of crude fat and phosphorus are significantly increased; the content of crude fiber is significantly reduced to 17.73%; and the content of crude ash is somewhat reduced, but not significantly;

(4) After urea treatment, the content of crude protein is significantly increased by 139.60%; the contents of crude fat and calcium are significantly increased; and the content of crude fiber, crude ash and phosphorus is significantly reduced.

(5) After sulfuric acid treatment, the content of crude protein is increased, but not significantly; the contents of crude ash, calcium and phosphorus are increased significantly; and the contents of crude fiber and crude fat are decreased significantly.

(6) After cellulase treatment, the content of crude fiber in the pods is significantly reduced by 26.57%; the content of crude protein is significantly increased by 22.91%; the contents of crude fat, phosphorus and total energy and other nutrients are reduced, of which the contents of crude fat and phosphorus are significantly reduced; at the same time, the content of calcium is significantly increased; and the content of crude ash is increased, but not significantly.

### DETAILED DESCRIPTION OF THE EMBODIMENTS

The present disclosure provides a method for increasing content of nutritional components of winged bean pods, comprising the following steps: (1) soaking a winged bean pod in water and mixing with an aqueous sodium chloride solution, and then steaming to obtain a softened pod;

(2) treating the softened pods with an alkaline substance or an acidic substance or cellulase.

In some embodiments, the nutritional components of the pods include crude protein, crude fat, crude fiber, crude ash, calcium and phosphorus.

In the present disclosure, when the content of nutritional components of the winged bean pod is increased, the winged bean pod is soaked in water and mixed with the aqueous sodium chloride solution, and the softened bean pod is obtained after steaming. In the present disclosure, when the soaking is performed, a mass ratio of the pods to the water is preferably 1:0.5-1.5; the soaking time is preferably changed with seasonal changes, specifically 3 h in summer and autumn, and 4-6 h in winter and spring. The soaking of the present disclosure can make the pods preliminarily softened. The pods of the present disclosure are preferably winged bean pods, and more preferably, they are chopped or crushed before soaking. In the present disclosure, the particle size of the chopped or crushed pods is not particularly limited, as long as it can reach the particle size for feeding.

During the mixing in the present disclosure, the weight ratio of the aqueous sodium chloride solution to the pods after soaking is preferably 1:1-3; a mass percentage of sodium chloride in the aqueous sodium chloride solution is preferably 1%. In the present disclosure, the mixing is preferably accompanied by stirring. In the present disclosure, the stirring speed is not specifically limited. In the present disclosure, it is allowed to stand after the mixing, the standing is preferably carried out in a closed container, and a time of the standing is preferably 12-24 h. The mixing in the present disclosure is a salting treatment, which can promote further softening of the pods.

The steaming of the present disclosure is preferably steaming in an environment of 90-100° C. for 50-70 min, and more preferably 60 min. After the steaming, the present disclosure preferably further includes drying in a drying oven at 65° C. to obtain a steamed softened pod.

After the softened pods are obtained, alkaline substances or acidic substances or cellulase is used in the present disclosure to treat the softened pods. The alkaline substance of the present disclosure preferably includes sodium hydroxide, quicklime, slaked lime, aqueous ammonia or urea; and the acidic substance preferably includes sulfuric acid.

In the present disclosure, when the softened pods are treated with sodium hydroxide, an aqueous solution of the sodium hydroxide is preferably mixed with the softened pods, and then sealed for 10-14 h; a mass ratio of the aqueous sodium hydroxide solution to the softened pods is preferably 1:2-5; and a mass percentage of sodium hydroxide in the aqueous sodium hydroxide solution is preferably 1-2%, and more preferably 1.5%.

In the present disclosure, when the softened pods are treated with quicklime, the quicklime is preferably mixed with the softened pods and water, and then sealed for 24-36 h; and a mass ratio of the quicklime, softened pods and water is 1:75-125:200-300; and more preferably 1:100:250.

In the present disclosure, when the softened pods are treated with slaked lime, the slaked lime is preferably mixed with the softened pods and water, and then sealed for 24-36 h; and a mass ratio of the slaked lime, softened pods and water is 3:75-125:200-300; and more preferably 3:100:250.

In the present disclosure, when the softened pods are treated with aqueous ammonia, the analytically pure aqueous ammonia is preferably mixed with the softened pods at a mass ratio of 1:25-40, more preferably 3:100, and then sealed for 25-35 d, and more preferably 30 d; and a mass percentage of ammonia in the aqueous ammonia is 8-12%; and more preferably 10%.

In the present disclosure, when the softened pods are treated with an aqueous urea solution, the aqueous urea solution is preferably mixed with the softened pods at a mass ratio of 1:25-40, and more preferably 3:100; and then sealed for 30-35 d; and the mass percentage of urea in the aqueous urea solution is 3-7%, more preferably 5%.

In the present disclosure, when the softened pods are treated with an aqueous sulfuric acid solution, the aqueous sulfuric acid solution is preferably mixed with the softened pods at a ratio of 5-15 mL:1 g, and reacted at 120° C. for 30 min, the ratio is more preferably 10 mL:1 g; and a mass percentage of sulfuric acid in the aqueous sulfuric acid solution is 0.5-1.5%, more preferably 1%.

In the present disclosure, when the softened pods are treated with cellulase, the softened pods are preferably allowed to stand at 75° C. for 8-12 h to balance the moisture, the softened pods after the balance of moisture are mixed with an acetic acid-sodium acetate buffer containing cellulase with a pH of 4.85 and hydrolyzed at 50° C. for 24 h; a mass ratio of the softened pods after the balance of moisture to the acetic acid-sodium acetate buffer solution containing cellulase is 5-15 g:1 mL, preferably 10 g:1 mL; and a mass volume concentration of cellulase in the acetic acid-sodium acetate buffer containing cellulase is 2.5 mg/mL.

The method of the present disclosure can be used to prepare bean pods with increased content of nutritional components, and the obtained bean pods can be used in feed, which may improve the palatability of the feed. In the present disclosure, the type of the feed is not specifically limited.

The method of the present disclosure may prepare bean pods with improved content of nutritional components. The obtained bean pods are used in feed, mainly used in the diets of ruminants and monogastric animals, and are mainly added to complete feeds. The addition amount in the diet of monogastric animals is generally 2-15%, which can be used as roughage to feed ruminants. The method for increasing content of nutritional components of the winged bean pods provided by the present disclosure and use thereof will be described in detail below in conjunction with examples, but they should not be understood as limiting the protection scope of the present disclosure.

### Comparative Example

Winged beans were planted at the base of Tuoyuan Village, Shimen Township, Hecheng District, Huaihua City. Normal water and fertilizer management and pest control were carried out. The fully matured winged bean pods were dried and the beans were stripped to obtain the pods, which were chopped or crushed and stored in a dry and cool place.

### Example 1

(1) Soaking and softening: the amount of water for soaking was equal to that of the chopped or crushed pods, and the soaking time was 3 h.

(2) Salinization treatment: 1% aqueous sodium chloride solution was mixed and stirred thoroughly with the chopped or crushed pods that were twice the weight after soaking, then placed in a closed container for 12-24 h to be softened naturally.

(3) Steaming: the salted pods were steamed at 100° C. for 60 min, and then dried in a 65° C. drying oven to get the steamed and softened pods.

(4) Sodium hydroxide treatment: 30 g of 1.5% sodium hydroxide solution was sprayed directly on 100 g of the steamed and softened pods, and stirred while spraying.

The processed pods were sealed in a 1000 mL beaker for 12 h.

### Example 2

(1) Soaking and softening: the amount of water for soaking was equal to that of the chopped or crushed pods, and the soaking time was 3 h.

(2) Salinization treatment: 1% aqueous sodium chloride solution was mixed and stirred thoroughly with the chopped or crushed pods that are twice the weight after soaking, then placed in a closed container for 12-24 h to be softened naturally.

(3) Steaming: the salted pods were steamed at 100° C. for 60 min, then dried in a 65° C. drying oven to get the steamed and softened pods.

(4) Limewater treatment: 1 g of quicklime or 3 g of slaked lime was added with 250 mL of water, the resulting solution was used to treat 100 g of the steamed and softened pods, and the processed pods were sealed in a 1000 mL beaker for 24-36 h.

### Example 3

(1) Soaking and softening: the amount of water for soaking was equal to that of the chopped or crushed pods, and the soaking time was 3 h.

(2) Salinization treatment: 1% aqueous sodium chloride solution was mixed and stirred thoroughly with the chopped or crushed pods that were twice the weight after soaking, then placed in a closed container for 12-24 h to be softened naturally.

(3) Steaming: the salted pods were steamed at 100° C. for 60 min, then dried in a 65° C. drying oven to get the steamed and softened pods.

(4) Aqueous ammonia treatment: 3 g of analytically pure aqueous ammonia was used to prepare a 10% ammonia solution, the solution was sprayed directly on 100 g of the steamed and softened pods, and the processed pods were sealed for 30 d.

### Example 4

(1) Soaking and softening: the amount of water for soaking was equal to that of the chopped or crushed pods, and the soaking time was 3 h.

(2) Salinization treatment: 1% aqueous sodium chloride solution was mixed and stirred thoroughly with the chopped or crushed pods that were twice the weight after soaking, and then placed in a closed container for 12-24 h to be softened naturally.

(3) Steaming: the salted pods were steamed at 100° C. for 60 min, and then dried in a 65° C. drying oven to get the steamed and softened pods.

(4) Urea ammoniating method: 3 g of urea was used to prepare a 5% urea aqueous solution, the solution was sprayed directly on 100 g of the steamed and softened pods, and the processed pods were sealed in a beaker for 30-35 d.

### Example 5

(1) Soaking and softening: the amount of water for soaking was equal to that of the chopped or crushed pods, and the soaking time was 3 h.

(2) Salinization treatment: 1% aqueous sodium chloride solution was mixed and stirred thoroughly with the chopped or crushed pods that were twice the weight after soaking, and then placed in a closed container for 12-24 h to be softened naturally.

(3) Steaming: the salted pods were steamed at 100° C. for 60 min, and then dried in a 65° C. drying oven to get the steamed and softened pods.

(4) Acidification treatment: the steamed and softened pods were reacted at 120° C. for 30 min in a sulfuric acid solution with a solid-to-liquid ratio of 1:10 (g:mL) and a mass fraction of sulfuric acid of 1%.

The processed pods obtained in Examples 1-5 were analyzed for the nutritional components. The content of crude protein was determined by the semi-micro Kjeldahl method; the content of crude fat was determined by the Soxhlet extraction method; the content of crude fiber was determined by the acid-base digestion method; the content of crude ash was determined by the burning method; the total energy was determined by the combustion method; the content of calcium was determined by the potassium permanganate titration method; and the content of phosphorus was determined by the molybdenum blue method. The results are shown in Table 1.

Example 1: Compared with the Comparative Example, after sodium hydroxide treatment, the nutrient components of the winged bean pods changed significantly: the content of crude protein was increased significantly after treatment, reaching 32.53%; the contents of crude fiber, crude fat, phosphorus and the total energy were significantly reduced; and the content of crude ash was significantly increased by 61.81%.

Example 2: Compared with the Comparative Example, after lime (quicklime/slaked lime) treatment, the content of crude protein was significantly increased by 24.33%; the contents of crude fat, crude ash, calcium and phosphorus were greatly increased; and the content of crude fiber was significantly reduced, at the same time the total energy was significantly reduced.

Example 3: Compared with the Comparative Example, after ammoniating treatment, the content of crude protein was significantly increased by 86.28%, the contents of crude fat and phosphorus were significantly increased, and the content of crude fiber was significantly reduced to 17.73%; and the content of crude ash was reduced, but not significantly.

Example 4: Compared with the Comparative Example, after urea treatment, the content of crude protein was significantly increased by 139.60%; the contents of crude fat and calcium were greatly increased; and the contents of crude fiber, crude ash and phosphorus were significantly reduced.

Example 5: Compared with the Comparative Example, after sulfuric acid treatment, the content of crude protein was increased, but not significantly; the contents of crude ash, calcium and phosphorus were increased significantly; and the contents of crude fiber and crude fat were decreased significantly.

TABLE 1
The effect of different chemical treatments on the nutrient components of
winged bean pods

| nutrient | Comparative | | | | | | | | |
|---|---|---|---|---|---|---|---|---|---|
| components | Example | Example 1 | | Example 2 | Example 3 | | Example 4 | Example 5 | |
| crude | 7.07 ± 0.26 | 9.37 ± | 1.00^{# #} | 8.79 ± 0.67^{# #} | 13.17 ± | 0.28^{# #} | 16.94 ± 1.05^{# #} | 8.09 ± | 0.85 |
| protein/% | | | | | | | | | |
| crude fiber/% | 39.26 ± 0.75 | 34.44 ± | 1.8^{# #} | 33.51 ± 2.21^{# #} | 32.20 ± | 0.88^{# #} | 33.01 ± 2.06^{# #} | 35.83 ± | 0.40^{# #} |
| crude fat/% | 1.03 ± 0.11 | 0.72 ± | 0.06^{# #} | 1.27 ± 0.12^{# #} | 2.16 ± | 0.21^{# #} | 1.96 ± 0.04^{# #} | 0.50 ± | 0.02^{# #} |
| crude ash/% | 8.09 ± 0.06 | 13.09 ± | 1.79^{# #} | 11.01 ± 0.02^{# #} | 7.90 ± | 0.15 | 4.33 ± 0.16^{# #} | 10.41 ± | 0.30^{# #} |
| total energy/ | 16.81 ± 0.43 | 14.44 ± | 1.33^{# #} | 14.86 ± 0.17^{#} | 15.40 ± | 0.57 | 16.13 ± 0.01 | 17.24 ± | 1.31 |
| MJ/kg | | | | | | | | | |
| calcium/% | 0.23 ± 0.01 | 0.33 ± | 0.03 | 3.64 ± 0.12^{# #} | 0.27 ± | 0.03 | 1.55 ± 0.07^{# #} | 2.94 ± | 0.15^{# #} |
| phosphorus/% | 0.10 ± 0.01 | 0.06 ± | 0.01^{# #} | 0.13 ± 0.00^{# #} | 0.13 ± | 0.00^{# #} | 0.06 ± 0.01^{# #} | 0.15 ± | 0.01^{# #} |

Note:
In the same line of example and the comparative example, shoulder label ^{#} indicates significant difference (p < 0.05, the same below); ^{# #} indicates extremely significant difference (p < 0.01, the same below); no mark indicates that the difference was not significant (p > 0.05, the same below).

### Example 6

(1) Soaking and softening: the amount of water for soaking was equal to that of the chopped or crushed pods, and the soaking time was 3 h.

(2) Salinization treatment: 1% aqueous sodium chloride solution was mixed and stirred thoroughly with the chopped or crushed pods that were twice the weight after soaking, and then placed in a closed container for 12-24 h to be softened naturally.

(3) Steaming: the salted pods were steamed at 100° C. for 60 min, then dried in a 65° C. drying oven to get the steamed and softened pods.

(4) Cellulase dilution: 250 mg of cellulase powder (produced by Shanghai Dongfeng Biochemical Technology Co., Ltd., with a standard activity of 1:1500 filter paper activity/g) was weighed, and 50 mL of 0.05 mol/L acetic acid-sodium acetate buffer with pH of 4.85 was added to fully dissolve, centrifuged at 3000 r/min for 10 min, rinsed and centrifuged again, and finally the volume was adjusted to 100 mL.

(5) Cellulose enzymatic hydrolysis of winged bean pods: the winged bean pods that have been steamed and softened were kept at 75° C. overnight to balance the moisture; 50 g of the pretreated pods after the balance of moisture were weighed, and a 0.05 mol/L acetic acid-sodium acetate buffer with pH of 4.85 according to the solid content of 10% was added, and hydrolyzed for 24 h at 50° C.

The content of nutritional components of the pods prepared in Example 6 was determined. The results are shown in Table 2. Compared with the Comparative Example, after the cellulase treatment, the content of crude fiber in the pods was significantly reduced by 26.57%; the content of crude protein was increased by 22.91%; the content of crude fat, phosphorus and total energy and other nutrients was reduced, of which the content of crude fat and phosphorus was significantly reduced; at the same time, the content of calcium was significantly increased; and the content of crude ash was increased, but not significantly.

TABLE 2
The effect of cellulase treatment on the nutritional
components of winged bean pods

| nutritional components | Comparative Example | Example 6 |
|---|---|---|
| crude protein (%) | 7.07 ± 0.26 | 8.69 ± 0.44^{#} |
| crude fiber (%) | 39.26 ± 0.75 | 28.83 ± 0.09^{# #} |
| crude fat (%) | 1.03 ± 0.11 | 0.64 ± 0.06^{# #} |
| crude ash (%) | 8.09 ± 0.06 | 8.43 ± 0.25 |
| total energy (MJ / kg) | 16.81 ± 0.43 | 15.45 ± 0.49 |
| calcium (%) | 0.23 ± 0.01 | 2.21 ± 0.01^{# #} |
| phosphorus (%) | 0.10 ± 0.0 | 0.03 ± 0.01^{# #} |

The above are only the preferred embodiments of the present disclosure. It should be pointed out that for those of ordinary skill in the art, without departing from the principle of the present disclosure, several improvements and modifications can be made, and these improvements and modifications should also be regarded as the protection scope of the present disclosure.

What is claimed is:

1. A method for increasing content of nutritional components of winged bean pods, comprising the following steps: (1) soaking a winged bean pod in water and mixing with an aqueous sodium chloride solution, and then steaming to obtain a softened pod; and
(2) treating the softened pod with an alkaline substance or an acidic substance or cellulase.

2. The method according to claim 1, wherein the nutritional components of the pods include crude protein, crude fat, crude fiber, crude ash, calcium and phosphorus.

3. The method according to claim 1, wherein during the soaking in step (1), a mass ratio of the pods to water is 1:0.5-1.5; and a soaking time is 3-6 h.

4. The method according to claim 1, wherein during the mixing in step (1), a mass percentage of sodium chloride in the aqueous sodium chloride solution is 1%, and a weight ratio of the aqueous sodium chloride solution to the pods after soaking is 1:1-3.

5. The method according to claim 4, wherein after the mixing, the method further comprises standing in a closed environment, and a standing time is 12-24 h.

6. The method according to claim 1, wherein the steaming in step (1) is steaming at 90-100° C. for 50-70 min.

7. The method according to claim 1, wherein the alkaline substance in step (2) comprises sodium hydroxide, quicklime, slaked lime, aqueous ammonia or urea; and the acidic substance comprises sulfuric acid.

8. The method according to claim 7, wherein when the softened pods are treated with sodium hydroxide, an aqueous solution of the sodium hydroxide is mixed with the softened pods and then sealed for 10-14 h; a mass ratio of the aqueous sodium hydroxide solution to the softened pods is 1:2-5; and a mass percentage of sodium hydroxide in the aqueous solution of the sodium hydroxide is 1-2%;
when the softened pods are treated with quicklime, the quicklime is mixed with the softened pods and water, and then sealed for 24-36 h; and a mass ratio of the quicklime, softened pods and water is 1:75-125:200-300;
when the softened pods are treated with slaked lime, the slaked lime is mixed with the softened pods and water, and then sealed for 24-36 h; and a mass ratio of the slaked lime, softened pods and water is 3:75-125:200-300;
when the softened pods are treated with aqueous ammonia, analytically pure aqueous ammonia is mixed with softened pods at a mass ratio of 1:25-40, and then sealed for 25-35 d; and a mass percentage of ammonia in the aqueous ammonia is 8-12%;
when the softened pods are treated with an aqueous urea solution, the aqueous urea solution is mixed with the softened pods at a mass ratio of 1:25-40, and then sealed for 30-35 d; and a mass percentage of urea in the aqueous urea solution is 3-7%;
when the softened pods are treated with an aqueous sulfuric acid solution, the aqueous sulfuric acid solution is mixed with the softened pods at a ratio of 5-15 mL:1 g, and reacted at 120° C. for 30 min; and a mass percentage of sulfuric acid in the aqueous sulfuric acid solution is 0.5-1.5%.

9. The method according to claim 7, wherein when the softened pods are treated with cellulase, the softened pods are allowed to stand at 75° C. for 8-12 h to balance the moisture, the softened pods after the balance of moisture are mixed with an acetic acid-sodium acetate buffer containing cellulase with a pH of 4.85 and hydrolyzed at 50° C. for 24 h; a mass ratio of the softened pods after the balance of moisture to the acetic acid-sodium acetate buffer containing cellulase is 5-15 g:1 mL; and a mass volume concentration of cellulase in the acetic acid-sodium acetate buffer containing cellulase is 2.5 mg/mL.
